(19) United States
(12) Patent Application Publication
(10) Pub. No.: US 2014/0361742 A1
(43) Pub. Date: Dec. 11, 2014

(54) ELECTRIC VEHICLE CHARGER

(71) Applicant: Hong Kong Productivity Council, Hong Kong (HK)

(72) Inventors: Chi-yung CHUNG, Hong Kong (HK); Hon-lung CHAN, Hong Kong (HK)

(21) Appl. No.: 13/912,219

(22) Filed: Jun. 7, 2013

(51) Int. Cl. B60L 11/18

(52) U.S. Cl. CPC B60L 11/1811
USPC 320/109

(57) ABSTRACT

An electric vehicle charger includes a DC/DC converter and control circuits. The DC/DC converter includes an inverter module; a transformer module connected to the inverter module; and a converter module connected to the transformer module. The control circuits includes a multi-loop feedback control system connected to the converter module; and gate driving circuits connected to the multi-loop feedback control system and the inverter module. The inverter module includes an IGBT bridge. The transformer module includes a transformer. The converter module includes a diode rectifier bridge.

### FIELD OF THE PATENT APPLICATION

The present patent application generally relates to power electronics and more specifically to an electric vehicle charger that is stable, safe, and small sized, and charges fast and with high efficiency.

### BACKGROUND

The oil has been used more and more in many kinds of industries as well as in social lives. The oil reserve has become much less than before. Renewable energy is the trend. EVs (electric vehicles) are now widely used in some developed countries such as Japan. The EV has some advantages compared with traditional petrol cars: it makes little damage to the environment, consumes less energy, and has a higher efficiency. Nowadays smart grids are very popular, and the EVs also have some contributions to it. EVs need to be recharged repeatedly and it is desirable to have an EV charger that is stable, safe, and small sized, and charges fast and with high efficiency.

### SUMMARY

The present patent application is directed to an electric vehicle charger. In one aspect, the electric vehicle charger includes a DC/DC converter and control circuits. The DC/DC converter includes an inverter module; a transformer module connected to the inverter module; and a converter module connected to the transformer module. The control circuits includes a multi-loop feedback control system connected to the converter module; and gate driving circuits connected to the multi-loop feedback control system and the inverter module.

The inverter module includes an IGBT bridge. The transformer module includes a transformer. The converter module includes a diode rectifier bridge.

The transformer may include a transformer core that is made of nano-crystalline materials. The IGBT bridge may include four IGBTs and four diodes being connected with each other, and the diode rectifier bridge may include four diodes being connected with each other. The electric vehicle charger may further include a heat sink and a metal plate. The heat sink is configured to dissipate heat generated by all the diodes, and the metal plate is inserted between the DC/DC converter and the control circuits.

The control circuits may be configured to use a power source that is isolated from the DC/DC converter. The electric vehicle charger may further include a front-end filter connected to an AC power supply. The inverter module is connected to the front-end filter.

The DC/DC converter may further include an active clamp circuit. The active clamp circuit includes two diodes, a capacitor, and an inductor being connected with each other, and is configured to reduce a surge voltage across the diode rectifier bridge.

The DC/DC converter may further include a saturable inductor connected to an input side of the transformer. The magnetic flux density of the saturable inductor may keep approximately constant when the magnetic field intensity of the saturable inductor increases and reaches a saturation point.

The gate driving circuits may be configured to turn on all the IGBTs for 50% of the time no matter what duty cycle is required. The multi-loop feedback control system may be configured to control an output current and an output voltage of the DC/DC converter by phase shift control through a current control loop and a voltage control loop respectively, and the reference of the current control loop may be calculated from the output of the voltage control loop.

The multi-loop feedback control system may be configured to apply a PI controller in the current control loop to regulate the output current to a reference current, and to set a saturation output for the PI controller so that the output current is clamped to a maximum output current. The multi-loop feedback control system may be configured to take the current control loop as a transfer function, and apply another PI controller before the transfer function in the voltage control loop to regulate the output voltage to a reference voltage. The multi-loop feedback control system may be configured to clamp the voltage control loop and to set the output current to be the maximum output current through the current control loop when the output current has reached the maximum output current; and may be configured to set the output voltage to the reference voltage through the voltage control loop, when the output current has not reached the maximum output current.

In another aspect, the electric vehicle charger includes at least one DC/DC converter and control circuits. Each DC/DC converter includes: an inverter module; a transformer module connected to the inverter module; and a converter module connected to the transformer module. The control circuits include a multi-loop feedback control system connected to the converter module; and gate driving circuits connected to the multi-loop feedback control system and the inverter module. The inverter module includes an IGBT bridge. The transformer module includes a transformer. The converter module includes a diode rectifier bridge. The multi-loop feedback control system is configured to control an output current and an output voltage of the at least one DC/DC converter through the gate driving circuits by phase shift control.

Each DC/DC converter may further include an active clamp circuit. The active clamp circuit includes two diodes, a capacitor, and an inductor being connected with each other, and is configured to reduce a surge voltage across the diode rectifier bridge.

Each DC/DC converter may further include a saturable inductor connected to an input side of the transformer. The magnetic flux density of the saturable inductor may keep approximately constant when the magnetic field intensity of the saturable inductor increases and reaches a saturation point.

In yet another aspect, the electric vehicle charger includes a plurality of DC/DC converters and control circuits connected to the DC/DC converters and configured to control an output current and an output voltage of the DC/DC converters. Each DC/DC converter includes an inverter module; a transformer module connected to the inverter module; and a converter module connected to the transformer module. For each DC/DC converter, the inverter module includes an IGBT bridge. The transformer module includes a transformer. The converter module includes a diode rectifier bridge.

The control circuits may be configured to control the output current and the output voltage of each of the DC/DC converters by phase shift control through a current control loop and a voltage control loop respectively, and the reference of the current control loop may be calculated from the output of the voltage control loop.

The control circuits may be configured to apply a PI controller in the current control loop to regulate the output current to a reference current, and to set a saturation output for the PI controller so that the output current is clamped to a maximum output current.

The control circuits may be configured to take the current control loop as a transfer function, and apply another PI controller before the transfer function in the voltage control loop to regulate the output voltage to a reference voltage.

### BRIEF DESCRIPTIONS OF THE DRAWINGS

FIG. 1 is a schematic diagram of an electric vehicle charger according to an embodiment of the present patent application.

FIG. 2 is a schematic diagram of the DC/DC converter depicted in FIG. 1.

FIG. 3 is a schematic diagram of an active clamp circuit in the DC/DC converter depicted in FIG. 2.

FIG. 4 illustrates the working principle of a saturable inductor in the DC/DC converter depicted in FIG. 2.

FIG. 5 shows waveform of important points of the PSFB.

FIG. 6 is a block diagram illustrating a current control loop according to an embodiment of the present patent application.

FIG. 7 is a block diagram illustrating a current and voltage double loop.

FIG. 8 is an efficiency curve of the electric vehicle charger depicted in FIG. 1.

FIG. 9 illustrates waveforms of ZVS (zero-voltage switching)

FIG. 10 illustrates waveforms of ZCS (zero-current switching).

FIG. 11 is a photo of an IGBT Driver board using CONCEPT.

FIG. 12 is a photo of a prototype of a 10 kW converter.

### DETAILED DESCRIPTION

Reference will now be made in detail to a preferred embodiment of the electric vehicle charger disclosed in the present patent application, examples of which are also provided in the following description. Exemplary embodiments of the electric vehicle charger disclosed in the present patent application are described in detail, although it will be apparent to those skilled in the relevant art that some features that are not particularly important to an understanding of the electric vehicle charger may not be shown for the sake of clarity.

Furthermore, it should be understood that the electric vehicle charger disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

FIG. 1 is a schematic diagram of an electric vehicle charger according to an embodiment of the present patent application. Referring to FIG. 1, the electric vehicle charger is a quick charger of 50 kW including a front-end filter 101 connected to an AC power supply, an inverter module 103 connected to the front-end filter 101, a transformer module 105 connected to the inverter module 103, a converter module 107 connected to the transformer module 105, a hybrid multi-loop feedback control system 109 connected to the converter module 107, and high current gate driving circuits 111 connected to the hybrid multi-loop feedback control system 109. The high current gate driving circuits 111 are also connected to the inverter module 103. The combination of the inverter module 103, the transformer module 105, and the converter module 107 may be referred to as a DC/DC converter, which will be described hereafter in more detail. The multi-loop feedback control system 109 is configured to control an output current and an output voltage of the DC/DC converter through the gate driving circuits 111 by phase shift control, which will be described in more detail hereafter.

It is understood that in an alternative embodiment, the EV charger may include a number of DC/DC converters. The multi-loop feedback control system 109 is configured to control an output current and an output voltage of each of the DC/DC converters through the gate driving circuits 111 by phase shift control.

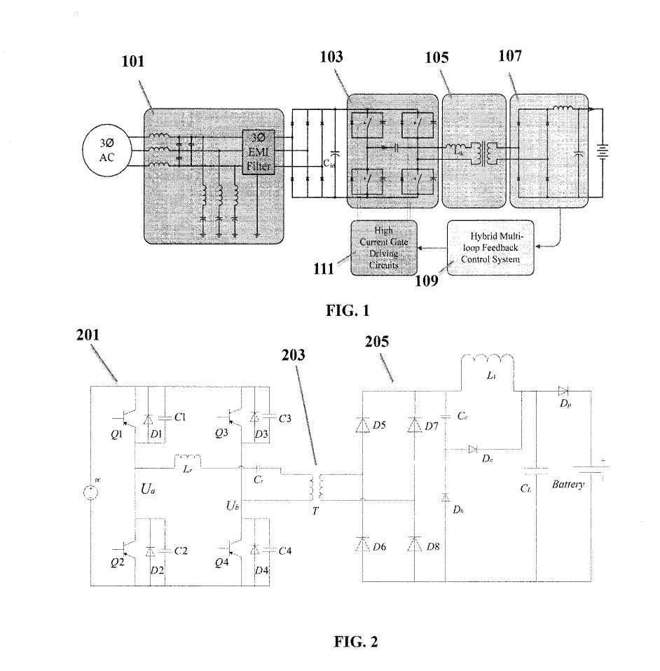

FIG. 2 is a schematic diagram of the DC/DC converter depicted in FIG. 1. In this embodiment, the DC/DC converter is a 10 kW DC/DC converter. The input voltage V_{dc} is DC 540V, and the output voltage is DC 50˜400V. Referring to FIG. 2, the DC/DC converter includes an IGBT (insulated-gate bipolar transistor) full bridge 201 including four IGBTs Q1-Q4 and four diodes D1-D4 being connected with each other; a transformer 203; and a diode rectifier bridge 205 including four diodes D5-D8 being connected with each other. From another perspective, the inverter module 103 includes the IGBT full bridge 201; the transformer module 105 includes the transformer 203; and the converter module 107 includes the diode rectifier bridge 205.

The system's switching frequency is 20 kHz. The transformer core of the transformer 203 is made of nano-crystalline materials, which has a high Bₘₐₓ so that the volume of the transformer 203 can be reduced significantly. Referring to FIG. 2, eight diodes D1-D8 are disposed at both sides of the transformer 203. Only one heat sink is used for these eight diodes, which saves much space. In other words, the heat sink is configured for dissipating heat generated by all eight diodes. In order to reduce the EMC, a metal (for example iron) plate is inserted between the power circuits and the control circuits. Here the power circuits include the circuits of the DC/DC converter, which include the inverter module 103, the transformer module 105, and the converter module 107. The control circuits include the multi-loop feedback control system 109 and the gate driving circuits 111. This means the electromagnetic fields generated by the power circuits are isolated from the electromagnetic fields generated by the control circuits. The power source for the control circuits is isolated from the power source of the DC/DC converter (220V_{ac}) in order to guarantee the safety. In other words, the control circuits are configured to use a power source that is isolated from the DC/DC converter.

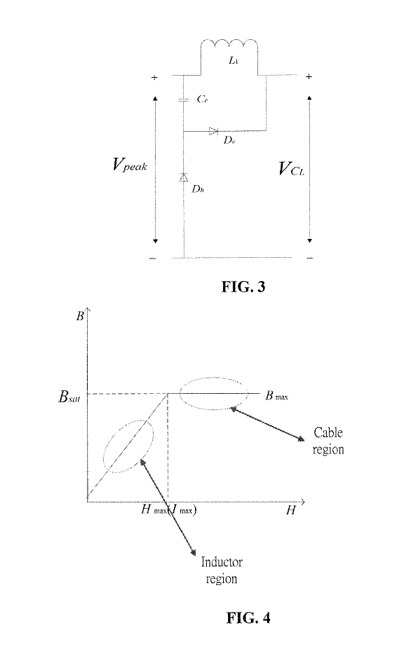

The DC/DC converter as depicted in FIG. 2 further includes an active clamp circuit, which is configured to help the rectifier diode's surge voltage become much lower. FIG. 3 is a schematic diagram of the active clamp circuit. Referring to FIG. 3, the active clamp circuit includes two diodes (Dₕ and D_{c}), a capacitor C_{c} and an inductor L₁ being connected with each other, and is configured to reduce the surge voltage across the diode rectifier bridge 205. Because the input voltage V_{dc} is 540V, and the ratio of the transformer 203 is 1, the output voltage across the diode rectifier bridge 205 is 540V. Generally, the surge voltage is nearly double the amplitude of the rectifier output voltage, and hence the surge voltage is almost 1080V. 1200V diodes are chosen as the rectifier diodes. The active clamp circuit has two main advantages. First, the surge voltage carries considerable energy, if no clamp circuit or some kind of passive clamp circuit is used, the energy will be wasted. The active clamp circuit can transport such energy to the load, which improves the efficiency. Second, the surge voltage can be reduced to be below 1000V, so that 1000V diodes can be used instead of 1200V diodes. The 1000V diodes have much better performance than the 1200V diodes, such as that V_{F} is smaller and the response speed is faster. These two advantages make the on-state losses and reverse recovery losses of 1000V diodes smaller than those of the 1200V diodes. These two advantages improve the efficiency and enhance the performance.

Referring to FIG. 2, the DC/DC converter further includes a saturable inductor Lᵣ being connected to the input side of the transformer 203. FIG. 4 illustrates the working principle of the saturable inductor. Referring to FIG. 4, the inductor is a linear inductor when the inductor current is low, and essentially a cable when the inductor current is high. The inductance can be adjusted by designing an air gap therein. More specifically, a B-H curve of a ferrite core of the inductor is shown in FIG. 4. It shows that if the magnetic field intensity (H) is high enough (increases to reach a saturation point Hₘₐₓ), the magnetic flux density (B) will not increase as the magnetic field intensity (H) increases. Instead, the magnetic flux density (B) keeps constant approximately. The electric current generates the magnetic field while the magnetic flux generates the voltage. So when the current is high, the inductor will become a wire. This design also has two advantages. The first one is expounded in ZCS (zero-current switching) technology. The second advantage is that it can reduce duty cycle loss. In a conventional phase shift full bridge circuit, a leakage inductor is generally used as the assisting inductor to achieve ZVS (zero-voltage switching) Although this method can save an inductor and some space, and when the load is light it also has good performance, when the load is heavy, the circuit usually can't output the full voltage. As the current increases, the leakage inductor voltage increases. Then the transformer voltage (the voltage across the left side or the input side of the transformer 203) gets smaller, and as a result the output voltage of the transformer 203 gets smaller. If the output needs to be higher for a heavy load, the ratio of the transformer needs to be increased. The primary current must also be increased. Hence bigger IGBT, and bigger core and cable need to be chosen. That means the on-state loss of the IGBT will increase, and the core loss will increase, and the size of the transformer will become bigger. The design provided by this embodiment solves this problem. With a light load, the current is small. The situation is similar to the leakage inductor. With a heavy load, as the current increase, the inductance of the saturable inductor becomes smaller, the voltage across the inductor gets smaller, and thereby the voltage across the input side of the transformer 203 gets higher. With a very heavy load, the inductor becomes a cable, and thereby it will not decrease the output voltage of the transformer 203.

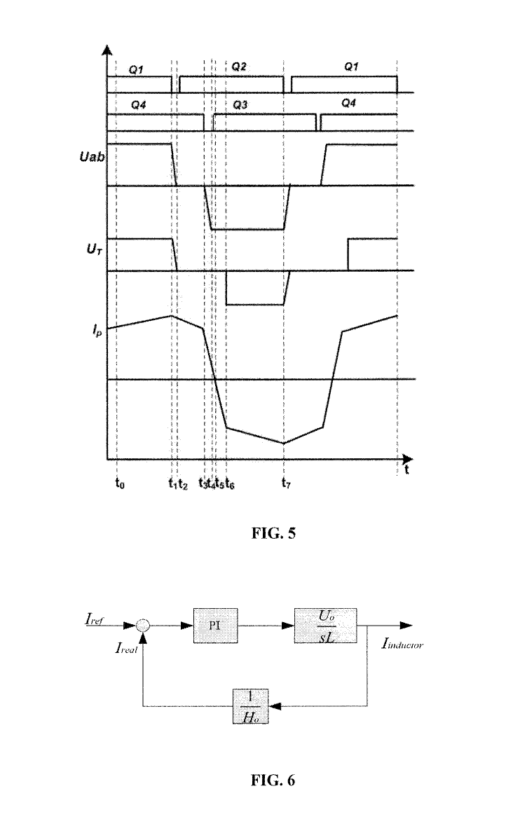

FIG. 5 shows the waveforms of important points of the PSFB of the DC/DC converter. t₅˜t₆ is a duty cycle loss. Using the saturable inductor decreases the duty cycle loss. Referring to FIG. 2 and FIG. 5, at t1, Q1 is turned off. Uₐ decreases to zero at t₂. At this moment D₂ is turned on, and the current flows through D₂. The voltage of C₂ is clamped to zero. Then the IGBT Q2 is turned on. So Q2 is achieving zero voltage switching. The time that Uₐ needs to decrease to zero is

$$Δ t = \frac{{U}_{dc} ( C 1 + C 2 )}{{I}_{o}} .$$

Io is the output current. So if the dead time between Q1 and Q4 is set to be longer than Δt, ZVS is achieved. A similarly analysis can be made to Q1. At t₃ the primary current Iₚ (the current flowing through Dₚ) begins to decrease. Because of the saturable inductor Lᵣ, when Iₚ becomes smaller, the inductance becomes bigger. So the current decreases more slowly. Then it takes a longer time for Iₚ to approach to zero. At this longer time Q4 is turned off, and hence zero current switching proximately to Q4 is achieved. There is a wide range of time to turn off Q4, therefore it is easier to achieve ZCS, and accurate control is not required. A similar analysis can be made to Q3.

The design of the control circuits is described hereafter. The current and voltage of the power converter need to be controlled. Software protection needs to be implemented, which includes output over current protection, short circuit protection, and input and output voltage protection. Local control is also needed because it is not only used in a 50 kW charger but also possibly used in a 10 kW charger. If it is used in 10 kW charger, local control must be used to operate the DC/DC converter. So the local control contains starting the converter, stopping the converter, and error signaling of the converter.

As shown in FIG. 5, phase shift control is used by the multi-loop feedback control system 109 to control the output current and the output voltage of the DC/DC converter through the gate driving circuits 111. The phase shift angle is adjusted to control the current and the voltage. This is very different from the traditional pulse width modulation (PWM) control method, wherein the width of the wave is adjusted. For example, when 80% duty cycle is needed, the IGBTs Q1 and Q4 are turned on for 40% of the time, and the IGBTs Q2 and Q3 are turned on for the other 40% of the time. The four IGBTs are all turned off for the 20% of the time. Q1 and Q2 are symmetrical, so are Q3 and Q4. In the phase shift control method being used in this embodiment, the gate driving circuits are configured to turn on all the IGBTs for 50% of the time no matter what duty cycle is required. What is the same is that Q1 and Q2 are symmetrical, so are Q3 and Q4. If the duty cycle needs to be adjusted to 80%, Q4 will be turned on with a 10% time lag compared to the time when Q1 is turned on, and Q3 will be turned on with a 10% time lag compared to the time when Q2 is turned on. Hence Q1 and Q2 are called lead half bridge, Q3 and Q4 are called lag half bridge. In a practical system, the lead half bridge is often fixed. According to the voltage and current required, the phase shift angle is calculated, and then only Q3 and Q4 are shifted. There are two advantages using this control method. One is soft switching which has been expounded before. The other one is that this method can decrease the surge voltage of the primary bus significantly. So like the active clamp circuit, it let one choose IGBT more easily, and V_{ces} can decrease. That makes V_{F} decrease, and the on-state loss decrease. So the phase shift control can not only decrease the switching losses but also decrease the on-state losses. It is noted that in the case of phase shift control, two IGBTs are turned on at any time; while in the case of PWM control, there is no IGBT that is on when the duty cycle is not 100%. IGBTs will dissipate more energy when it is in on-state than it is in off-state. All the descriptions above do not include the dead time.

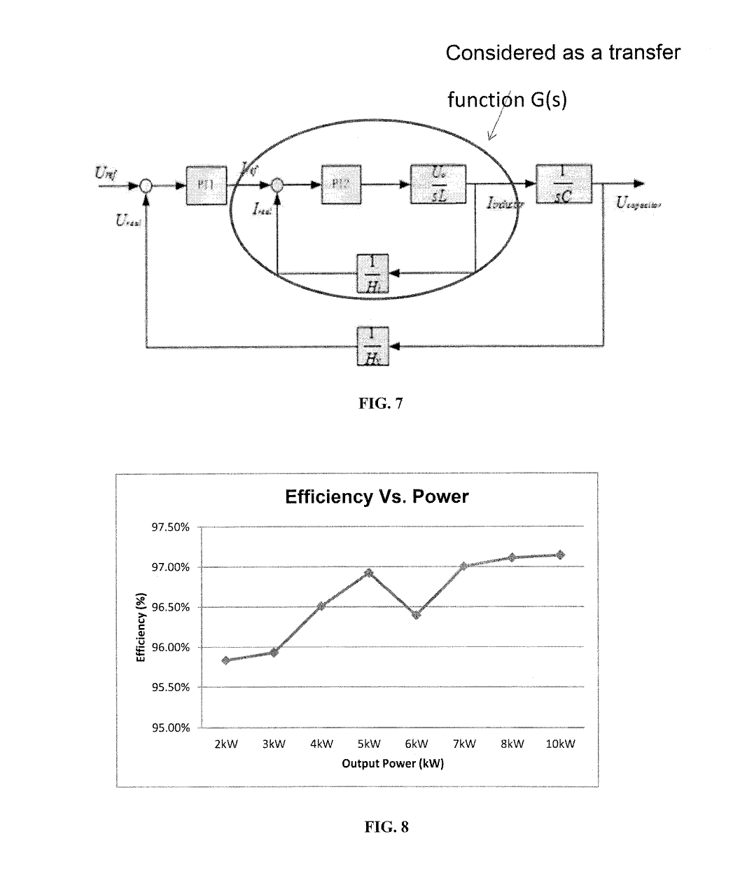

FIG. 6 and FIG. 7 illustrate the operations of the multi-loop feedback control system of the 10 kW EV charger according to another embodiment of the present patent application. FIG. 6 is a block diagram illustrating a current control loop (the inner loop). This control loop is used to control the exact current of the inductor L₁ (referring to FIG. 2) so that the output current can be exactly controlled. FIG. 7 is a block diagram illustrating a current and voltage double loop. The output voltage can be controlled so as to switch from a current charging mode to a voltage charging mode automatically. The inductor L₁'s current is controlled in the current control loop, and the capacitor C_{L}'s voltage is controlled in the voltage control loop. In the current control loop, the control object is an inductor and its transfer function is 1/sL, so a PI (proportional and integral feedback) comparator (also referred to as a PI controller, which is shown as PI in FIG. 6 and PI2 in FIG. 7) is applied to regulate the output current to a reference current I_{ref}. The PI comparator has a characteristic that it has no static error so that the current can be controlled precisely. A saturation output is set for the PI comparator, so the output current will be clamped to 25 A for any situation. A voltage control loop is configured as the outer loop to control the output voltage of the DC/DC converter. As shown in FIG. 7, the reference of the inner loop (the current control loop) I_{ref} is calculated from the output of the outer loop (the voltage control loop) U_{capacitor}. The inner current control loop is taken as a transfer function G(s), and the same method used in the current control loop can be used to design the voltage control loop, which is essentially applying another PI controller (shown as PI1 in FIG. 7) before the transfer function G(s) to regulate the output voltage to a reference voltage U_{ref}. Because a maximum current value is set at the inner loop, when the output of the voltage loop has not made the output current reach the limit, it is the double loop control that the multi-loop feedback control system is executing to control the output voltage of the DC/DC converter. In other words, in this case, the voltage control loop sets the output voltage to the reference voltage U_{ref}. When the output of the outer loop has made the output current reach the maximum output current value of the inner loop, the output of the outer loop is clamped, the outer loop doesn't work, the reference of the current loop is 25 A (the maximum output current), and so is the output current. There is only a single loop working, which is the current control loop. Hence the system works as the following. When the charger starts to charge the EV, its current is high, the output of the converter is clamped to 25 A, and it is a current source; at the end of the charging, the output current has decreased, the output of the converter is clamped to 400V, it is a voltage source. So the converter can distinguish the status of the EV, and can output either as a current source or as a voltage source. This is adaptive control method and it is easy for several modules to work in parallel.

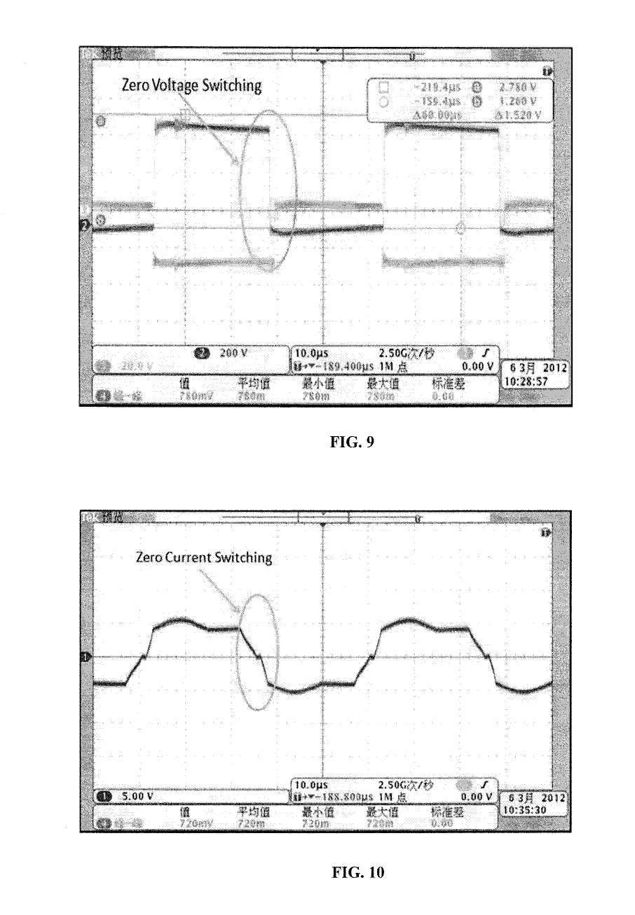

FIG. 8 is an efficiency curve of the electric vehicle charger depicted in FIG. 1. It depicts eight points (2 kW˜10 kW) to form the efficiency curve. From FIG. 8, it can be seen the system has a very high efficiency, because zero voltage switching and zero current switching are achieved using the saturable inductor technology. FIG. 9 illustrates waveforms of ZVS. The curves in FIG. 9 represent the Q2's collector to emitter's voltage and the Q2's gate to emitter's voltage. From the curves, it can be seen that first V_{ce} decrease to zero, and then goes to 30V. So the Q2 achieves ZVS. FIG. 10 illustrates waveforms of ZCS. The curve represents the primary of the transformer's current. When the current reaches zero, there is a short delay, and during this delay time Q2 is turned off. So Q2 achieves ZCS. Switching losses are generally very significant for IGBT. Because of the IGBT's tail current, it has a very large turn off loss. As shown in FIGS. 8-10, the ZCS and ZVS are achieved, which makes the efficiency very high.

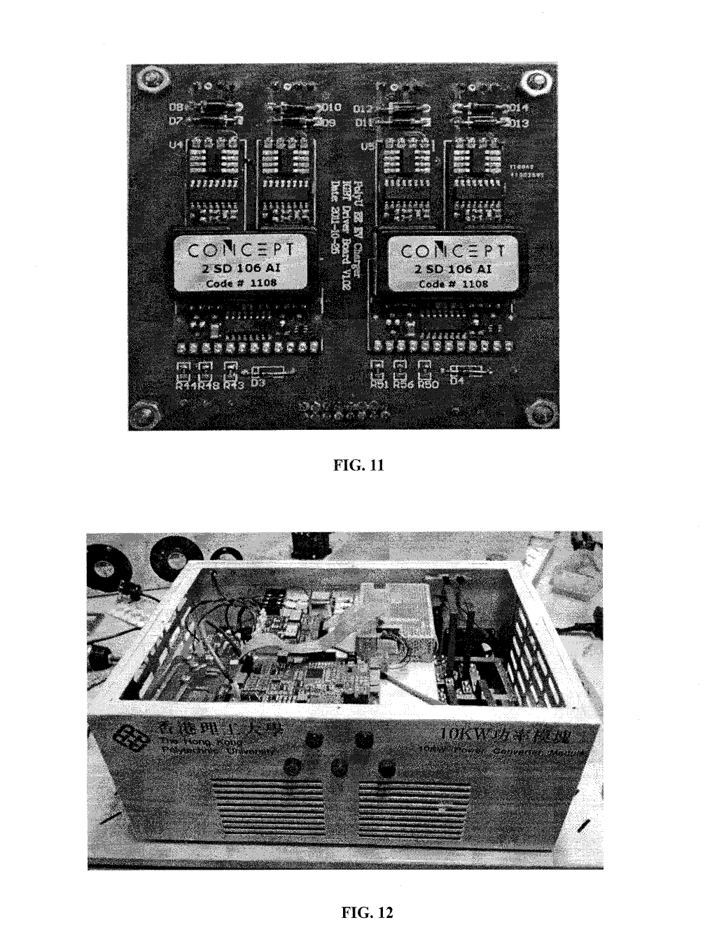

FIG. 11 is a photo of an IGBT Driver board implemented by CONCEPT Dual SCALE Driver 2SD106 A. It can drive two IGBTs so that only two drivers are needed to drive four IGBTs. And it has magnetic isolation from the control circuit and the power circuit, so that there is no need to isolate the power supply for every driver. Only one 15V power supply is sufficient. It simplifies the design and makes the manufacture easier, more stable and safer. The driver has 6 A drive capability, which makes the IGBTs capable of switching fast and stable. It also can generate the dead time automatically by the hardware circuit, which is much safer than generating the dead time by software with a MCU. The most important function used in CONCEPT is IGBT over current protection. The IGBTs being used are in a switch mode, which means each IGBT is either in on-state mode or off-state mode. When it is in on-state mode, the current of the IGBT is non-zero and the voltage of the IGBT is zero, while when it is in off-state mode, the current of the IGBT is zero and the voltage of the IGBT is non-zero. Hence if the current and voltage are both non-zero, it means the IGBT is working in a liner range, which is never allowed to happen in the power supply. The CONCEPT detects the V_{ce} and I_{c} of every IGBT, if a IGBT has non-zero Use and non-zero I_{c}, the driver will shut off the four IGBTs immediately, which makes the system very safe. FIG. 12 is a photo of a prototype of a 10 kW converter. This prototype complies with a number of standards, such as Japan CHAdeMO, China Southern Power Grid, and so on.

The above-mentioned embodiments provide a high power fast EV charger. The EV charger implements a topology of the power circuit and a control method. It has the following advantages. The charger uses a number of 10 kW modules in parallel operation. It makes the system more stable and safer. It can also operate abundantly. It has a very high efficiency. The charger achieves more than 95% efficiency from 10 kW output to 50 kW output. For one module, it can achieve more than 97% efficiency in 10 kW output. The charger has a small size compared with other similar products. The charger can output voltage in a range of 50˜400V, and output current 0˜125 A. It can be used to charge many types of vehicles. There is no need for any kind of auxiliary equipment. The charger can recharge 80% of the battery capacity (i.e. 80% state of charge, or SOC) of an EV in half an hour.

While the present patent application has been shown and described with particular references to a number of embodiments thereof, it should be noted that various other changes or modifications may be made without departing from the scope of the present invention.

What is claimed is:

1. An electric vehicle charger comprising:
a DC/DC converter, the DC/DC converter comprising:
an inverter module;
a transformer module connected to the inverter module; and
a converter module connected to the transformer module; and
control circuits, the control circuits comprising:
a multi-loop feedback control system connected to the converter module; and
gate driving circuits connected to the multi-loop feedback control system and the inverter module; wherein:
the inverter module comprises an IGBT bridge;
the transformer module comprises a transformer; and
the converter module comprises a diode rectifier bridge.

2. The electric vehicle charger of claim 1, wherein the transformer comprises a transformer core that is made of nano-crystalline materials.

3. The electric vehicle charger of claim 1, wherein the IGBT bridge comprises four IGBTs and four diodes being connected with each other, and the diode rectifier bridge comprises four diodes being connected with each other.

4. The electric vehicle charger of claim 3 further comprises a heat sink and a metal plate, wherein the heat sink is configured to dissipate heat generated by all the diodes, and the metal plate is inserted between the DC/DC converter and the control circuits.

5. The electric vehicle charger of claim 1, wherein the control circuits are configured to use a power source that is isolated from the DC/DC converter.

6. The electric vehicle charger of claim 1 further comprising a front-end filter connected to an AC power supply, wherein the inverter module is connected to the front-end filter.

7. The electric vehicle charger of claim 1, wherein the DC/DC converter further comprises an active clamp circuit, the active clamp circuit comprises two diodes, a capacitor, and an inductor being connected with each other, and is configured to reduce a surge voltage across the diode rectifier bridge.

8. The electric vehicle charger of claim 1, wherein the DC/DC converter further comprises a saturable inductor connected to an input side of the transformer, and the magnetic flux density of the saturable inductor keeps approximately constant when the magnetic field intensity of the saturable inductor increases and reaches a saturation point.

9. The electric vehicle charger of claim 1, wherein the gate driving circuits are configured to turn on all the IGBTs for 50% of the time no matter what duty cycle is required.

10. The electric vehicle charger of claim 1, wherein the multi-loop feedback control system is configured to control an output current and an output voltage of the DC/DC converter by phase shift control through a current control loop and a voltage control loop respectively, and the reference of the current control loop is calculated from the output of the voltage control loop.

11. The electric vehicle charger of claim 10, wherein the multi-loop feedback control system is configured to apply a PI controller in the current control loop to regulate the output current to a reference current, and to set a saturation output for the PI controller so that the output current is clamped to a maximum output current.

12. The electric vehicle charger of claim 11, wherein the multi-loop feedback control system is configured to take the current control loop as a transfer function, and apply another PI controller before the transfer function in the voltage control loop to regulate the output voltage to a reference voltage.

13. The electric vehicle charger of claim 12, wherein the multi-loop feedback control system is configured to clamp the voltage control loop and to set the output current to be the maximum output current through the current control loop when the output current has reached the maximum output current; and is configured to set the output voltage to the reference voltage through the voltage control loop, when the output current has not reached the maximum output current.

14. An electric vehicle charger comprising:
at least one DC/DC converter, each DC/DC converter comprising:
an inverter module;
a transformer module connected to the inverter module; and
a converter module connected to the transformer module; and
control circuits, the control circuits comprising:
a multi-loop feedback control system connected to the converter module; and
gate driving circuits connected to the multi-loop feedback control system and the inverter module; wherein:
the inverter module comprises an IGBT bridge;
the transformer module comprises a transformer;
the converter module comprises a diode rectifier bridge; and
the multi-loop feedback control system is configured to control an output current and an output voltage of the at least one DC/DC converter through the gate driving circuits by phase shift control.

15. The electric vehicle charger of claim 14, wherein each DC/DC converter further comprises an active clamp circuit, the active clamp circuit comprises two diodes, a capacitor, and an inductor being connected with each other, and is configured to reduce a surge voltage across the diode rectifier bridge.

16. The electric vehicle charger of claim 14, wherein each DC/DC converter further comprises a saturable inductor connected to an input side of the transformer, and the magnetic flux density of the saturable inductor keeps approximately constant when the magnetic field intensity of the saturable inductor increases and reaches a saturation point.

17. An electric vehicle charger comprising:
a plurality of DC/DC converters, each DC/DC converter comprising:
an inverter module;
a transformer module connected to the inverter module; and
a converter module connected to the transformer module; and
control circuits connected to the DC/DC converters and configured to control an output current and an output voltage of the DC/DC converters; wherein:
for each DC/DC converter, the inverter module comprises an IGBT bridge;
the transformer module comprises a transformer; and
the converter module comprises a diode rectifier bridge.

18. The electric vehicle charger of claim 17, wherein the control circuits are configured to control the output current and the output voltage of each of the DC/DC converters by phase shift control through a current control loop and a voltage control loop respectively, and the reference of the current control loop is calculated from the output of the voltage control loop.

19. The electric vehicle charger of claim 18, wherein the control circuits are configured to apply a PI controller in the current control loop to regulate the output current to a reference current, and to set a saturation output for the PI controller so that the output current is clamped to a maximum output current.

20. The electric vehicle charger of claim 19, wherein the control circuits are configured to take the current control loop as a transfer function, and apply another PI controller before the transfer function in the voltage control loop to regulate the output voltage to a reference voltage.
